(19) United States
(12) Patent Application Publication
(10) Pub. No.: US 2012/0122194 A1
(43) Pub. Date: May 17, 2012

(54) METHOD FOR THE TOTAL GASIFICATION OF GARBAGE OR WASTE

(75) Inventor: Pierre Dumons, Toulouse (FR)

(73) Assignee: D.M.S., Toulouse (FR)

(21) Appl. No.: 13/386,123

(22) PCT Filed: Jul. 20, 2009
(86) PCT No.: PCT/FR09/51441

§ 371 Date: Jan. 20, 2012

(51) Int. Cl. C02F 3/28

(52) U.S. Cl. 435/262

(57) ABSTRACT

A method for treating garbage or waste in which the garbage or refuse is subjected to at least one compression step (14) under conditions enabling the separation thereof into a putrescible fraction (15) in the form of a moist pulp, and into a dry fraction (16) with a relative moisture of less than 20%, then the putrescible fraction is subjected to a treatment (17) by anaerobic fermentation producing a biogas (18), characterized in that the resulting dry fraction (16) is subjected to an endothermic gasification treatment (19).

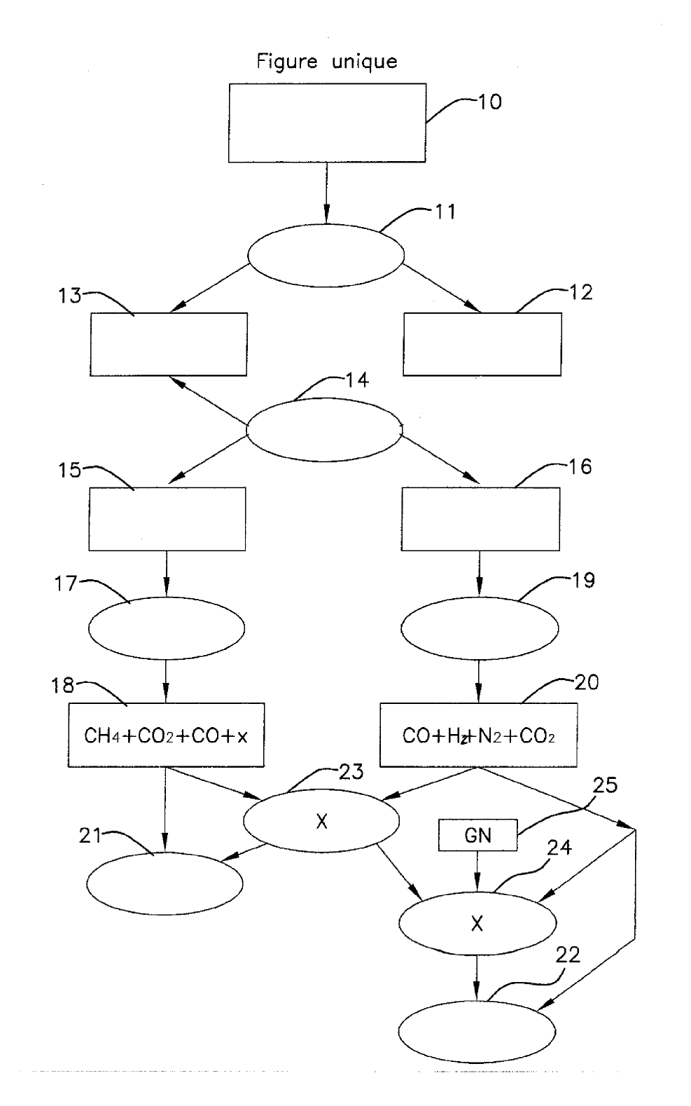

The invention relates to a method for the treatment of garbage or waste which permits its optimal exploitation.

Garbage or waste such as household waste, agricultural waste (liquid manure, plant waste), agroalimentary waste represents an important source of energy which it is desirable to be able to exploit in the optimal manner. Hitherto, garbage or waste substantially gave rise to the problem of removing or rendering it inert. Part of the energy contained in the garbage or waste is optionally recovered during these operations. Nevertheless, the treatments applied hitherto to such garbage or waste have not been truly optimized with a view to exploiting the energy it contains.

The direct incineration of raw waste produces complex and toxic emanations, requiring treatment of the fumes, and residues from the purification of the fumes. The presence of a large amount of moisture in the garbage or waste impairs its yield considerably, and the proportion of ash produced is high, typically from 30 to 32%. This solution, which was very widespread hitherto, requires heavy equipment, is costly and does not allow optimal exploitation of the waste in terms of energy.

In order to remedy these disadvantages it is now preferred first to separate the materials capable of undergoing anaerobic fermentation and thus produce “biogas” by methanization. Such materials include on the one hand putrescible materials of animal or vegetal origin and on the other hand cellulosic materials (paper, cardboard, etc.). Nevertheless, the steps of separating these materials are complex and expensive and, moreover, the internal energy of the other materials resulting from the raw garbage or waste, for example non-recyclable synthetic polymeric materials, is not exploited.

EP 0563173 describes a method for the treatment of garbage or waste in which, after extraction of the inert materials (materials which are neither combustible nor putrescible, such as glass, metals, etc.), the non-inert garbage or waste is compressed up to a final pressure greater than 800 bar (800 10⁵ Pa), which permits separation of a moist fraction and a combustible fraction. The moist fraction, which is composed substantially of biomass, can be treated by known methods, for example by appropriate biological seeding, in order to produce either, by aerobic fermentation, composts or, by anaerobic fermentation (methanization producing “biogas”), gases capable of providing heat energy, the anaerobic fermentation digestate itself being compostable. The solid combustible fraction of low relative humidity (less than 20%) can be either directly and immediately incinerated in a boiler furnace or stored outside and then taken in again and incinerated during periods in order to respond to a deferred energy demand.

Nevertheless, this combustible fraction, which is still regarded as waste, remains subject to regulations concerning the treatment of waste. In particular, its incineration requires the use of a furnace which complies with regulations, a device for treatment of the fumes, and a solution for rendering inert the residues from the purification of the fumes. Consequently, it requires very costly investments.

In addition, there have recently been proposed devices and methods for the gasification of solid waste. WO 2007/037768 describes a particularly complex method which is supposed to be able to produce combustible gases from different types of waste. One of the steps of the method consists in carrying out gasification of the non-inert solid waste which has previously been dried, ground and packaged as granules. This method cannot be used in the case of waste containing a high proportion of biomass and is in any case extremely complex and non-competitive, the cost of the treatment being higher than the profits which can be made from the exploitation. Likewise, US 2007/0181047 describes a method for the treatment of solid waste, which method consists in drying the waste and then subjecting it to gasification in order to produce a combustible gas. Nevertheless, in this case too, the method cannot be applied to waste containing a high proportion of biomass and is in any case not competitive given the steps of drying, grinding and filtering which must be carried out prior to the gasification.

Within this context, the invention aims to propose a method for the treatment of garbage or waste which, on the one hand, is applicable to all types of garbage and waste, including those having a high content of biomass, and, on the other hand, permits the production, under competitive economic conditions on an industrial scale, of materials which are no longer waste and a minimal quantity of inert ultimate residues.

More particularly, the invention aims to propose such a method which allows the quantity of energy which can be recovered per unit mass of garbage or waste to be increased considerably.

In the following text, the units of gas volume (m³) are the normalized units, that is to say represent the volume occupied by a gas or gas mixture at a temperature of 0° C. and under a pressure of 1 bar (10⁵ Pa).

In the following text, the term endothermic gasification denotes a chemical reaction at least one of the products of which is a gas and the overall energy balance of which shows an absorption of energy, that energy being supplied especially in the form of heat. Exothermic combustion or oxidation denotes a chemical reaction the energy balance of which is positive, the energy produced especially being dissipated in the form of an emission of heat.

To that end, the invention relates to a method for the treatment of garbage or waste, in which:
garbage or waste is subjected to at least one compression step under conditions enabling it to be separated into a fraction, called the putrescible fraction, in the form of pulp of relative humidity greater than 50% and into a fraction, called the dry fraction, of relative humidity below 20%,
and then the putrescible fraction is subjected to an anaerobic fermentation treatment producing a biogas, wherein at least part of said dry fraction is converted by an endothermic gasification treatment.

The inventor has found, surprisingly, on the one hand that the moist fraction extracted by compression of the garbage or waste (after optional extraction of the inert materials), as described, for example, by EP 0563173, is composed of rapidly fermenting putrescible materials of animal or vegetal origin, and on the other hand that the dry fraction, which is formed of cellulose-based materials (paper, cardboard, etc.) and of synthetic polymeric materials (optionally including composite materials), can be subject to a simple endothermic gasification treatment which is of good yield and produces a synthetic gas (substantially a mixture of carbon monoxide, hydrogen, nitrogen and carbon dioxide) which can then be exploited directly by combustion, optionally in admixture with natural gas and/or with the biogas resulting from the methanization of the putrescible fraction.

The inventor has further found that the dry fraction, as is produced at the outlet of the press in the form of compact blocks of leaves, has a density substantially of the order of 0.85 and is non-flammable as a compact mass. However, the inventor has also observed that said dry fraction can easily be broken up, after simple shredding, into dry material having a pulverulent nature, which is consequently very reactive on combustion and gasification. The endothermic gasification of such a pulverulent dry material avoids the occurrence of preferential passages for the gases in the dry material and permits homogeneous treatment of the totality of said dry material.

In addition, the inventor has found that the dry fraction obtained after prior sorting followed by compression typically comprises substantially 93% material which is gasifiable by endothermic pyrolysis, 3% inert material which is neither combustible nor gasifiable nor fermentable, and only 4% putrescible organic material.

In particular, the inventor has found that the simple endothermic gasification treatment of a quantity of dry fraction, obtained by compression of garbage or waste (after optional extraction of the inert materials) formed of cellulose-based materials and of synthetic polymeric materials, produces a small quantity of ultimate residues which remain as waste. The proportion by mass of ultimate residues obtained after endothermic gasification of a quantity of dry fraction is less than 20% of the mass of the starting dry fraction, in particular less than 10%, especially substantially close to 5%.

Consequently, the method according to the invention enables the garbage or waste to be converted entirely into gases (which are not waste), compost, and inert materials (glass, metals and other recyclable materials, ultimate waste in a small quantity). In a method according to the invention, the non-inert materials are converted into gas, especially into combustible gas, having a high energy value with an excellent production yield and at low cost, which allows an overall waste exploitation rate greater than 90% to be achieved.

Furthermore, it is to be noted that the production cost of an installation for endothermic gasification and combustion of the synthesis gas obtained is much lower than that of an installation for combustion and treatment of fumes. Furthermore, in a method according to the invention, the totality of the putrescible materials is converted into biogas which can be used to produce energy and into compost having a content of organic matter greater than 30%, said compost being suitable for use as a fertilizer in agriculture.

Advantageously and according to the invention, the endothermic gasification treatment is carried out so as to produce a gaseous composition, called the synthesis gas, which comprises at least one combustible gas capable of being burnt by exothermic oxidation.

In particular, the endothermic gasification method according to the invention permits the production of a quantity of synthesis gas at least a proportion of which is oxidizable and which is capable of supplying energy on subsequent oxidizing combustion. The method of endothermic gasification of the dry fraction according to the invention therefore differs from the methods of incineration by combustion, which produce fully oxidized gases and which cannot be exploited in terms of energy.

Advantageously and according to the invention, the endothermic gasification treatment is carried out in a reactor, called the gasification reactor, so as to produce a synthesis gas comprising at least one combustible gas selected from the group formed of dihydrogen (H₂) and carbon monoxide (CO).

The endothermic gasification of said dry fraction is carried out and there is produced a synthesis gas composed substantially of dihydrogen (H₂) and of carbon monoxide (CO), which are combustible gases which can be oxidized and exploited, and, in lesser proportions, nitrogen (N₂) and carbon dioxide (CO₂). It is possible for an endothermic gasification treatment to produce nitrogen (N₂) and carbon dioxide (CO₂), but the total proportion of these two gases in the synthesis gas mixture will not exceed a molar proportion of 15%, typically approximately 10%. It is also possible for an endothermic gasification treatment according to the invention, for example in a reducing medium, to produce a quantity of synthesis gas containing methane (CH₄), a gas which is of particular interest by virtue of its low oxidation number (−4).

Advantageously and according to the invention, a quantity of energy for the endothermic gasification treatment is supplied in the form of heat energy. The inventor has observed that the increase in the temperature of the dry fraction composed of cellulose-based materials and of synthetic materials permits the production of synthesis gas, said synthesis gas being free of the toxic agents that are contained in the garbage or waste.

Advantageously and according to the invention, the endothermic gasification treatment is carried out starting from a plurality of reagents comprising at least said part of the dry fraction and steam. In particular, the dry fraction obtained by compression has a relative humidity below 20% on leaving the press. On storage of the dry fraction for deferred endothermic gasification treatment, the relative humidity of the fraction can increase and stabilize, for example, at a value of from 26% to 28%. According to a particular variant of a method according to the invention, the endothermic gasification treatment is carried out without supplying additional water. However, in another variant, the quantity of water required to carry out the endothermic gasification in the optimum manner is adapted by addition of an additional quantity of water, if necessary, depending on the particular chemical composition of the dry fraction. In a particular embodiment of a method according to the invention, the quantity of water required to carry out the endothermic gasification is supplied in the form of steam, by adding the steam to the endothermic gasification reactor during the endothermic gasification.

Moreover, the endothermic gasification treatment can be carried out in any manner known per se. For example, the endothermic gasification treatment is carried out, at atmospheric pressure, by arranging in a tank furnace, also called a gasifying furnace, a layer of dry fraction obtained from waste, through which there is injected an oxidant gas in the presence of a quantity of steam. It is also possible to use a reactor, called a “fixed bed” reactor, of the co-current or counter-current types, pressurized or non-pressurized, or another type of reactor.

Advantageously and according to the invention, the endothermic gasification treatment is carried out at a temperature of from 700° C. to 900° C. Preferably, the endothermic gasification treatment is carried out at a temperature of from 800° C. to 850° C. In particular, this endothermic gasification temperature is sufficient to carry out the endothermic gasification of at least part of the dry fraction of relative humidity below 20%.

Advantageously and according to the invention, at least part of the quantity of heat energy for the endothermic gasification treatment is provided by a combustion of at least part, called the part to be burnt, of the dry fraction with a quantity of oxidizing oxidant gas, said combustion being carried out in the gasification reactor. An oxidative combustion of part of the dry fraction with a quantity of oxidizing oxidant gas is carried out so as to produce the energy required to increase and maintain the temperature allowing the endothermic gasification reaction to take place.

In a first possible variant embodiment according to the invention, the endothermic gasification treatment and the combustion of said part to be burnt are carried out simultaneously in a single gasification reactor. Accordingly, the energy produced by combustion of said part to be burnt allows the temperature of the dry fraction to be increased, which dry fraction decomposes in the presence of steam, to give synthesis gas.

The inventor has found that the combustion of said part to be burnt brings about the production of non-combustible gases, especially carbon dioxide, but also advantageously enables the endothermic gasification temperature to be reached, at which exploitable combustible gases are produced. The oxidant gas is a gaseous composition comprising molecular oxygen. The oxidant gas is especially chosen from the group formed of atmospheric air and pure molecular oxygen. The oxidant gas is brought into contact with said part to be burnt by means of devices known per se which permit the introduction of a gaseous oxidant composition into a combustion furnace and also control of the quantity and the delivery speed of the quantity of oxidant gas in contact with said part to be burnt so as to maintain the optimum endothermic gasification temperature and optimize the production of exploitable synthetic gases which can be burnt by exothermic oxidation.

Advantageously, in the first variant according to the invention, the endothermic gasification treatment is carried out with a proportion by mass of said part to be burnt of from 5% to 25%, especially approximately 10%, of the dry fraction. The inventor has observed that the combustion in air of a small part, especially a proportion by mass of approximately 10%, of the dry fraction advantageously allows the additional fraction of 90% of said dry fraction to be gasified, producing a quantity of synthetic gases which can be exploited and burnt by exothermic oxidation, as well as a small quantity of ash and inert residues.

Advantageously, in the first variant according to the invention, the endothermic gasification treatment is carried out with a quantity of oxidizing oxidant gas of approximately 6000 m³ per tonne of said part to be burnt. The inventor has also determined that the quantity of oxidizing oxidant gas required for the oxidizing combustion of one tonne of dry fraction resulting from the compression of garbage or waste according to the invention is 6000 m³, this volume of oxidant gas thus permitting the gasification of about 9 tonnes of dry fraction resulting from the compression of garbage or waste.

Advantageously, in the first variant according to the invention, the endothermic gasification treatment is carried out starting from a quantity of oxidant gas which is first heated and then introduced into the gasification reactor, increasing the production yield of synthesis gas. Advantageously and according to the invention, said quantity of oxidant gas is heated by heat exchange between at least part of the synthesis gas produced by the endothermic gasification treatment and said quantity of oxidant gas. In particular, advantageously and according to the invention, a heat exchange is carried out between a quantity of a hot synthesis gas produced by the endothermic gasification treatment and said quantity of oxidant gas prior to its introduction into the gasification reactor. The result is that the quantity of oxidant gas is heated but also, advantageously, the synthesis gas produced is cooled.

In a second variant embodiment according to the invention, which can be combined with the first variant mentioned above, at least part of the quantity of heat energy required for the endothermic gasification treatment is produced outside the gasification reactor, it then being possible for said gasification reactor to be hermetically sealed, especially with respect to atmospheric gases. According to an embodiment of this second variant, the endothermic gasification treatment is carried out in a sealed gasification reactor, the endothermic gasification furnace of which is heated to a temperature of from 700° C. to 900° C. by heating means external to the gasification reactor. Heating means external to the reactor that are known per se are used, which make it possible to avoid producing, in the furnace of the endothermic gasification reactor, a quantity of non-combustible gas, especially a molar proportion of non-combustible gas greater than 10%.

Advantageously, in the second variant of the invention, the endothermic gasification treatment is carried out in a gas-tight endothermic gasification installation which is maintained under a pressure greater than atmospheric pressure, or alternatively in an installation which is maintained at low pressure so that the synthesis gas produced by endothermic gasification does not escape from the gasification installation and that the atmospheric gases do not penetrate into the inside of the gasification installation. The endothermic gasification treatment can advantageously also be carried out in installations, called revolving grate installations, from which the ash and inert gasification residues are evacuated automatically.

According to another embodiment of the second variant of the invention, the endothermic gasification treatment is carried out in a sealed gasification reactor, the endothermic gasification furnace of which is heated to a temperature of from 1200° C. to 1300° C. by heating means external to the gasification reactor in order to produce biofuels.

Advantageously, in the second variant of the invention, at least part of the quantity of heat energy for the endothermic gasification treatment is produced by a combustion, outside the gasification reactor, of at least part, called the part to be burnt, of the dry fraction with a quantity of oxidizing oxidant gas. In particular, the quantity of heat required for the endothermic gasification treatment is produced by the combustion of part of the dry fraction of relative humidity below 20%, which is consequently combustible, outside the gasification reactor, and said quantity of heat is transmitted to said endothermic gasification reactor. The gasification reactor is thus separate from the furnace in which the combustion of said part to be burnt takes place and cannot contain non-combustible gas coming from the combustion of said part to be burnt of the combustible dry fraction. Accordingly, in order to carry out the gasification of a major part of the dry fraction, the gasification reactor is heated by the separate combustion of a small part of the dry fraction. Advantageously, in either of the two variants of the invention mentioned above, at least part of the quantity of thermal energy for the endothermic gasification treatment is produced by combustion of part of the synthesis gas produced by endothermic gasification. Accordingly, a quantity of synthesis gas produced by an endothermic gasification treatment is advantageously used as fuel, optionally after storage, as the thermal energy source for a subsequent endothermic gasification treatment.

Moreover, advantageously and according to the invention, at least part of the quantity of thermal energy required for the endothermic gasification treatment is produced by combustion, inside and/or outside the endothermic gasification reactor, of part of the biogas produced by anaerobic fermentation of the putrescible fraction. In particular, at least part of the quantity of thermal energy required for the endothermic gasification treatment is produced by combustion of a gaseous composition comprising a quantity of biogas produced by anaerobic fermentation of the putrescible fraction and a quantity of synthesis gas produced by endothermic gasification of part of the dry fraction. The different variants mentioned above for producing the energy for the endothermic gasification can be combined.

The endothermic gasification reactor is further adapted to permit collection of the synthesis gases produced in the endothermic gasification treatment of the dry fraction resulting from the separation by compression. Furthermore, the endothermic gasification reactor is equipped with devices known per se which allow the dry fraction to be introduced into the endothermic gasification reactor, and with known devices which allow the ash and the inert gasification residues to be removed. The daily endothermic gasification capacity of the furnace of an endothermic gasification reactor can vary, according to the quantities of dry fraction to be gasified, from a capacity of typically from about one hundred kilograms to about ten hundred kilograms of dry fraction for small-scale applications to a capacity of several hundreds of tonnes of dry fraction for applications on an industrial scale.

Advantageously and according to the invention, prior to the separation by compression of the putrescible fraction and the dry fraction, a step of extraction of inert materials that are neither putrescible nor combustible is carried out, so that the garbage or waste resulting from this separation is substantially formed of non-inert materials. In particular, the putrescible fraction subjected to methanization and the dry fraction subjected to endothermic gasification are substantially free of inert materials that are neither putrescible nor gasifiable.

Advantageously and according to the invention, in order to separate the putrescible fraction and the dry fraction, said garbage or waste is compressed up to a pressure greater than 700 bar (700 10⁵ Pa), especially from 720 bar (720 10⁵ Pa) to 750 bar (750 10⁵ Pa), in at least one compression chamber provided with extrusion orifices through which the putrescible fraction flows.

The inventor has further observed an acceleration of the anaerobic fermentation speed, leading to a considerable reduction in the time required for this fermentation, owing to the penetration of the fermentation agents, facilitated by the destructuration of the animal and/or vegetal tissues under the combined effect of the high pressure applied to the garbage or waste during the compression and the variation in the pressure on extrusion.

Advantageously and according to the invention, the separation treatment is carried out at a site, called the separation site, which is separate from a site, called the gasification site, at which the endothermic gasification treatment is carried out. In particular, a site for separation of the waste by compression is chosen so that the distance separating that site from the household garbage production regions is minimized. The transport of freshly collected raw garbage is thus reduced, avoiding the nuisances which may be caused by the transport of said raw garbage or waste to the garbage or waste separation site. Furthermore, a site for endothermic gasification of the dry fraction is chosen so as to minimize the distance separating the sites at which gas is produced (by endothermic gasification) and the site at which the gas produced by endothermic gasification is converted into energy.

In particular, the site for anaerobic fermentation of the putrescible fraction is chosen to be close to the site for separation of the waste by compression, so as to reduce the period of time between the step of production and the step of controlled methanization of the putrescible fraction, while avoiding uncontrolled gas production outside a methanization tank. Furthermore, the closeness of the site of production of the putrescible fraction and the site of methanization of said putrescible fraction makes it possible especially to avoid the transportation, especially by road, of the putrescible fraction, which ferments rapidly and may cause nuisances for the environment during transportation.

Advantageously and according to the invention, the treatment by endothermic gasification of the dry fraction is carried out after a storage period. The dry fraction, which has a low content of putrescible material and a relative humidity below 20%, is particularly suitable for transportation and storage without causing nuisances. The stability of said dry fraction accordingly allows the production of gas to be deferred. Postponing the endothermic gasification treatment by temporarily storing the dry fraction allows the production of synthesis gas to be adapted in order to meet energy demands, especially demands for synthesis gas.

Advantageously and according to the invention, there is prepared a gas composition, called the recycling gas, comprising a quantity of synthesis gas and a quantity of at least one gas chosen from the group formed of said biogas and natural gas. The inventor has further observed that the gases constituting the synthesis gas produced by endothermic gasification of the dry fraction, and the biogas produced by anaerobic fermentation of the putrescible fraction, which gases are obtained according to the invention from garbage or waste, are no longer regarded as waste under regulations and can be used as a combustible starting material for the production of energy.

Advantageously and according to the invention, the recycling gas is stored prior to its combustion. Storage of the recycling gas obtained by a method according to the invention, said recycling gas being composed partly of biogas obtained by (deferred or immediate) anaerobic fermentation of the putrescible fraction resulting from the compression of the waste or garbage and partly of synthesis gas obtained by (deferred or immediate) endothermic gasification treatment of the dry fraction resulting from the compression of the waste or garbage, permits the use, itself immediate or deferred, of the recycling gas for energy demands in industrial sectors, in communities, for the production of electricity. Accordingly, prior to its combustion, the recycling gas is stored and, eventually, is transported in containers or by a system of pipes. In a particular embodiment of the invention, the biogas on the one hand and the synthesis gas on the other hand are stored separately. Furthermore, at least one step of purification of the biogas and of the synthesis gas is carried out.

Advantageously, at least 90%, typically from 93% to 95%, of the garbage or waste is converted into at least one combustible gas fraction capable of being burnt by exothermic oxidation, as a residual methanization compost comprising from 40% to 50% organic matter, and at least one fraction of inert materials that are neither putrescible nor combustible but for the most part are recyclable (glass, metals, etc.).

The invention relates also to a method characterized in combination by all or some of the features mentioned above or below.

Other objects, features and advantages of the invention will become apparent upon reading the following description of its embodiments given by way of non-limiting examples and which refers to the accompanying single FIGURE, which is a general schematic flow diagram of a method according to the invention.

The treatment method according to the invention is applied to a starting composition 10 which is composed of household garbage or of waste. The starting composition 10 can be formed of any composition of raw waste containing both putrescible materials (biomass) and non-putrescible materials (especially cellulose-based materials: paper, cardboard, etc., and synthetic polymeric materials: thermoplastics, thermosetting plastics, resins, textiles, etc.).

In the case of household garbage, the average composition resulting from an urban collection is typically as follows (by weight):
putrescible materials (biomass of animal or vegetal origin): 32%,
combustible materials: 45%, namely:
   substantially cellulosic materials: 34%
   synthetic polymeric or composite materials: 11%,
inert materials: 23%.

In a first step 11, the inert materials (that is to say the materials that are neither putrescible nor combustible nor gasifiable, such as metals, glass, etc.) are extracted. This extraction is carried out in the conventional manner by mechanical, automatic or manual sorting and/or by magnetic sorting. This extraction step 11 produces on the one hand inert materials 12, and a garbage or waste composition 13 resulting from the extraction, which is formed almost entirely of degradable (non-inert), that is to say evolutive, materials. Typically, in a household garbage composition, the inert materials 12 extracted by mechanical and/or magnetic sorting represent approximately from 20% to 25% of the starting composition 10.

The garbage or waste composition 13 obtained after extraction of the inert materials is subjected to a treatment 14 of separation by compression under high pressure in a press, up to a final pressure greater than 700 bar (700 10⁵ Pa), typically approximately from 720 bar (720 10⁵ Pa) to 750 bar (750 10⁵ Pa), which has the effect of separating:
a pulp 15 of relative humidity greater than 50%, composed of putrescible biomass, which is expelled under the effect of the high pressure through extrusion orifices of at least one compression chamber of the press,
a highly divided dry residue 16, of relative humidity below 20%, which is composed of scraps of combustible dry materials and is initially compact but separates when handled into pieces with very low cohesion.

The separation step 14 can be carried out in a manner known per se, for example as described in EP 0563173 or EP 1173325 or FR 2577167 or others.

The moist pulp 15 is the fraction of the garbage or waste composition 13 that is able to flow through the extrusion orifices under the effect of the pressure applied to the composition 13. The moist pulp 15, which is uniformly brown in colour and is in a more or less pasty state, in any case has a relatively high humidity, typically of from 50% to 60%, and constitutes a putrescible fraction which can immediately be dispatched for subsequent treatment elsewhere or can be treated in situ within the necessary time in order to take advantage of its property as a relatively pure biomass; it is subjected to a biological anaerobic fermentation treatment 17 which produces a biogas 18 comprising methane (typically approximately 60%), carbon dioxide, carbon monoxide and various other gases in lesser proportions.

The moist pulp 15 generated following the separation step 14 has a capacity for very rapid fermentation owing to the bursting, following the extrusion, of the cells constituting the putrescible organic material (of animal or vegetal origin). It further has a water retention capacity approximately 2.5 times its mass of dry matter.

Consequently, the moist pulp 15 does not allow liquid to escape.

The biological anaerobic fermentation treatment 17 of the moist pulp 15 further generates a residual methanization compost which comprises from 40% to 50% organic matter and is substantially free of undesirable inert or plastics materials and is particularly suitable for use as an agricultural fertilizer. In particular, the agricultural fertilizer complies with the French standard NF U44-051, which sets the minimum proportion of organic matter in the composition of composts at 30%. The residual methanization compost is further enriched with fertilizing mineral materials which are not modified during the methanization.

For example, the putrescible fraction 15 is subjected, immediately after the treatment 14 of separation by compression, to an anaerobic fermentation treatment 17 in a bioreactor as marketed by LINDE (Switzerland). Within a period of 3 weeks, the anaerobic fermentation treatment 17 of the putrescible fraction 15 results in the average production of 149 m³ of biogas per tonne of moist pulp 15 treated. The gas produced by the anaerobic fermentation treatment 17 of the putrescible fraction 15 is for the most part (60%) methane.

The dry fraction 16 is subjected to an endothermic gasification treatment 19 at a temperature of from 700° C. to 900° C., permitting the production of a synthetic gas 20 comprising carbon monoxide (typically approximately 45%), dihydrogen (typically approximately 50%) and, in lesser proportions, gaseous nitrogen (N₂) and carbon dioxide. The calorific power of the synthetic gas 20 so produced is from 12,500 kJ/m³ to 19,000 kJ/m³.

The dry fraction 16 contains both materials that are mainly cellulosic (paper, cardboard, sanitary textiles, etc.) and synthetic polymeric materials (including composite materials). This dry fraction can be subjected to an endothermic gasification treatment, with good yields and good conditions, in view especially of its low humidity, the absence of biomass and its particulate form without cohesion. Following this endothermic gasification treatment, a small proportion of inert ash is recovered in addition to the synthesis gas 20.

The biogas 18 can be subjected to a combustion 21, and the synthetic gas can be subjected to a combustion 22, it being possible for these combustions to be carried out in appropriate installations permitting the use of the gases 18, 20 as fuels, for example in boilers for heating installations or for the production of hot water, steam, or electricity production or the like. As shown schematically in the FIGURE, the biogas 18 and the synthetic gas 20 can be mixed wholly or partially with one another (mixing step 23) and/or with natural gas 25 (mixing step 24) before being used as fuels in a combustion step 21 and/or 22.

### EXAMPLE

Household waste (which is not subject to selective collection) collected from the Alès region (France), after removal of the inert materials, especially glass, metals, minerals, is treated by compression under 750 bar (750 10⁵ Pa), at a rate of 8.5 tonnes of waste per hour, in a tank pierced with multiple orifices. It is found that the waste so treated separates into an extruded fraction, which flows through the dies of the press, in the form of a putrescible organic pulp containing a proportion by mass of from 96 to 97% putrescible material, and a non-extruded fraction, called the dry fraction, which is retained inside the tank of the press and contains proportions by mass of 93% materials which can be subjected to pyrogasification (including 68% cellulosic materials, especially paper, cardboard, sanitary textiles, and 25% plastics), 3% inert incombustible materials (glass, metals, various minerals and other materials which have escaped the initial sorting) and 4% putrescible organic material.

The dry fraction is in the form of compact blocks of leaves which are easy to handle and the density of which is substantially close to 0.85 on leaving the press. It is observed that these blocks constituting the dry fraction, when stored in open air, are penetrated by rainwater only superficially and that the blocks of dry fraction consequently do not emit percolation water. It is further observed that the blocks constituting the dry fraction do not exhibit any appreciable sign of fermentation despite the presence of a small proportion of putrescible material (3%). The blocks of combustible material are inert and present no risk of spontaneous ignition. Nor do they give off any odor.

It has further been observed that the blocks of dry material are, in the form of compact masses, totally non-flammable and are therefore perfectly suited to secure storage. On the other hand, they can easily be broken up, by handling or shredding, in order to generate a dry fraction having a pulverulent nature in the form of scraps of paper, cardboard, plastics materials.

The degree of relative humidity of the dry fraction varies from 20% immediately after leaving the press and stabilizes at a value of from 26 to 28% after storage, as a result of natural re-humidification by the humidity of the air.

The elemental composition of the gasifiable dry fraction is as follows, in percent by mass of dry material: carbon 53.5%, dihydrogen 7.7%, sulfur 0.5%, dioxygen 37.0%, dinitrogen 0.7% and chlorine 0.6%.

A pilot experiment of endothermic gasification of the dry materials resulting from the compression of household garbage from which the inert material has been removed is carried out. Approximately from 150 to 200 kg of dry material obtained by separation by compression are placed in a sealed gasification reactor. The endothermic gasification temperature is maintained at a value of from 800° C. to 850° C. The relative portion of the reactor charge dedicated to the generation of the endothermic gasification conditions is approximately 10% of the dry material to be treated. The air consumption is approximately 0.6 m³ per kilogram of dry material. The air used for the combustion of part of the dry fraction is heated before it is introduced into the reactor by recovery of the heat emitted by the gas produced by gasification. A quantity of gas of 0.83 kg is obtained from 1 kg of dry fraction, composed of gaseous dihydrogen (H₂, 50%), carbon monoxide (45%) and, in lesser proportions, dinitrogen N₂ and carbon dioxide. The gas produced has a calorific value substantially close to 15,000 kJ/m³.

The invention can be the subject of numerous variant embodiments, especially as regards the methods and installations used for carrying out the treatments of separation by compression 14, anaerobic fermentation 17 or endothermic gasification 19. These treatments are known per se and can be chosen and optimized according to the compositions to be treated.

1. A method for the treatment of garbage or waste, in which:
garbage or waste is subjected to at least one compression step (14) under conditions enabling it to be separated into a fraction, called the putrescible fraction (15), in the form of a pulp of relative humidity greater than 50% and a fraction, called the dry fraction (16), of relative humidity less than 20%,
and then the putrescible fraction (15) is subjected to an anaerobic fermentation treatment (17) producing a biogas (18),
wherein at least part of said dry fraction (16) is converted by an endothermic gasification treatment (19) in which a quantity of energy is supplied in the form of heat energy provided by the combustion of at least another part, called the part to be burnt, of the dry fraction (16) comprising from 5% to 25%, especially substantially close to 10%, of the dry fraction (16).

2. The method as claimed in claim 1, wherein the endothermic gasification treatment (19) is carried out so as to produce a gaseous composition, called the synthesis gas, comprising at least one combustible gas capable of being burnt by exothermic oxidation.

3. The method as claimed in claim 2, wherein the endothermic gasification treatment (19) is carried out in a reactor, called the gasification reactor, so as to produce a synthesis gas comprising at least one combustible gas chosen from the group formed of dihydrogen (H₂) and carbon monoxide (CO).

4. The method as claimed in claim 1, wherein the endothermic gasification treatment (19) is carried out starting from a plurality of reagents comprising at least said part of the dry fraction (16) and steam.

5. The method as claimed in claim 1, wherein the endothermic gasification treatment (19) is carried out at a temperature of from 700° C. to 900° C.

6. The method as claimed in claim 1, wherein said combustion is carried out in the gasification reactor.

7. The method as claimed in claim 1, wherein the endothermic gasification treatment (19) is carried out with a quantity of oxidizing oxidant gas of approximately 6000 m³ per tonne of said part to be burnt.

8. The method as claimed in claim 7, wherein the endothermic gasification treatment (19) is carried out starting from the quantity of oxidant gas previously heated and then introduced into the gasification reactor.

9. The method as claimed in claim 8, wherein the quantity of oxidant gas is heated by heat exchange between at least part of the synthesis gas produced by the endothermic gasification treatment (19) and said quantity of oxidant gas.

10. The method as claimed in claim 3, wherein at least part of the quantity of heat energy required for the endothermic gasification treatment (19) is produced outside the gasification reactor.

11. The method as claimed in claim 10, wherein at least part of the quantity of heat energy for the endothermic gasification treatment (19) is produced by a combustion, outside the gasification reactor, of at least part, called the part to be burnt, of the dry fraction (16) with a quantity of oxidizing oxidant gas.

12. The method as claimed in claim 1, wherein at least part of the quantity of thermal energy for the endothermic gasification treatment (19) is produced by combustion of part of the synthesis gas produced.

13. The method as claimed in claim 1, wherein at least part of the quantity of thermal energy required for the endothermic gasification treatment (19) is produced by combustion of at least part of the biogas (18).

14. The method as claimed in claim 1, wherein, prior to the separation (14) by compression of the putrescible fraction (15) and the dry fraction (16), a step (11) of extraction of inert materials that are neither putrescible nor combustible is carried out, so that the garbage or waste (13) resulting from the separation (14) is substantially formed of non-inert materials.

15. The method as claimed in claim 1, wherein, in order to separate the putrescible fraction (15) and the dry fraction (16), said garbage or waste is compressed up to a pressure greater than 700 bar (700 10⁵ Pa), especially from 720 bar (720 10⁵ Pa) to 750 bar (750 10⁵ Pa), in at least one compression chamber provided with extrusion orifices through which the putrescible fraction (15) flows.

16. The method as claimed in claim 1, wherein the separation treatment (14) is carried out at a site, called the separation site, which is separate from a site, called the gasification site, at which the endothermic gasification treatment (19) is carried out.

17. The method as claimed in claim 1, wherein the endothermic gasification treatment (19) of the dry fraction (16) is carried out after a storage period.

18. The method as claimed in claim 1, wherein a gas composition, called the recycling gas, comprising a quantity of synthesis gas and a quantity of at least one gas selected from the group formed of said biogas (18) and natural gas is prepared and stored.

19. The method as claimed in claim 1, wherein the recycling gas is stored prior to its combustion.
